(19) United States
(12) Patent Application Publication
(10) Pub. No.: US 2018/0023819 A1
(43) Pub. Date: Jan. 25, 2018

(54) MODULAR BUILDING INTEGRATED THERMAL SYSTEM

(71) Applicants: Frank C. Pao, Boston, MA (US); Philip Angelo Germano, JR., Wappingers Falls, NY (US)

(72) Inventors: Frank C. Pao, Boston, MA (US); Philip Angelo Germano, JR., Wappingers Falls, NY (US)

(21) Appl. No.: 15/217,784

(22) Filed: Jul. 22, 2016

(51) Int. Cl. F24D 17/00; H02S 40/44; H02S 20/23; H02S 40/32; B23P 19/00; F24J 2/04

(52) U.S. Cl. CPC F24D 17/0021; B23P 19/00; F24J 2/045; H02S 20/23; H02S 40/32; H02S 40/44

(57) ABSTRACT

A building integrated modular thermal system is disclosed. A modular thermal unit comprises a plurality of metal battens having a longitudinal channel mounted horizontally onto a plurality of wooden battens, a thermal tubing containing liquid mounted on the longitudinal channels, a plurality of solar electric roof tiles mounted on the plurality of metal battens and connected in series to form a string, an inverter connected to each of the strings, an energy storage tank is connected between the thermal tubing, and a pump. The plurality of solar electric roof tiles generates DC electricity from solar energy and the inverter converts the DC electricity to AC electricity to feed to a utility grid. The plurality of metal battens collects the solar energy and converts into thermal energy through running the liquid which is extracted to the heat exchanger resulting in producing domestic hot water. The modular thermal unit and the thermal control system provide an easy installation with a removable modular structure.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE DISCLOSURE

This invention relates to roofing systems, and more particularly to a modular building integrated thermal system for an easy installation on the roof of the building.

### DISCUSSION OF RELATED ART

Solar energy has received increasing attention as an alternative renewable, non-polluting energy source, and photovoltaic installations on commercial and residential roofs are becoming increasingly popular. One important way to reduce global warming would be to use alternative or renewable energy, such as, solar energy which is environment friendly and cost effective in the long run than the conventional methods. A properly sized and easily installed solar thermal energy collection system with a removable modular structure can be a practical alternative for acquiring some of the energy needs.

Building integrated technology is most commonly applied as new roofing materials that replace an existing roof, either as a shingle comprised of thin film solar material, or thin film material rolled onto a metal roof and affixed with an adhesive. The photovoltaic roof that includes panels having a galvanized steel supporting layer with side supporting flanges interconnected to form a roof assembly (a typical standing seam roof). The mid portion of each panel has a photovoltaic surface made formed of amorphous semi-conductor material which is laminated onto the galvanized steel supporting layer. Moreover such a system is difficult to install and affect the integrity of the roof of the building.

An another existing prior art discloses a s roof installations consisting of an array of interfitting members e.g. tiles, strips, slats or the like which interfit to form a roof covering and a set of heat pipes which run parallel to the plane of the roof. Heat is extracted from the heat pipes and used directly or indirectly, e.g. via a heat pump apparatus. The solar heating system for mounting under a roof that includes a panel formed of a sheet material and at least one run of tubing held beneath the panel by a plurality of tubing fasteners. The panel assembly facilitates transfer of the trapped heat from the roof and surrounding air into the fluid circulating through the tubing. However, such a system is difficult to install at the roof of the building. Moreover, such a system does not have a removable modular structure.

The sun's energy can be collected in a variety of different ways. One is converting sun's energy into thermal energy to heat thing. The roof installations consisting of an array of interfitting members e.g. tiles, strips, slats or the like which interfit to form a roof covering and a set of heat pipes which run parallel to the plane of the roof. Heat is abstracted from the heat pipes and used directly or indirectly, e.g. via a heat pump apparatus. The solar heating system for mounting under a roof that includes a panel formed of a sheet material and at least one run of tubing held beneath the panel by a plurality of tubing fasteners. The panel assembly facilitates transfer of the trapped heat from the roof and surrounding air into the fluid circulating through the tubing. Such arrangements will not generate sufficient energy to be self-sustaining due to less conversion rate and these are not aesthetically pleasing.

Therefore, there is a need for a modular building integrated thermal system that provides easy installation with a removable modular structure. Such a needed system would provide a modular thermal unit for an easy installation on the roof of the building. Such a needed system would provide a pump and thermal control system. Further, such a device would effectively utilize the sun's energy, would be self-sustaining, aesthetically pleasing, and economical. The present invention accomplishes these objectives.

### SUMMARY OF THE DISCLOSURE

The present invention is a building integrated modular thermal modular thermal unit 10 that comprises a plurality of metal battens mounted horizontally onto a plurality of wooden battens that mounted vertically across a roof. Each of the plurality of metal battens includes a longitudinal channel that extends in a longitudinal direction on opposing sides thereof. A thermal collector having a thermal tubing structure extending along the longitudinal channel, the thermal tubing structure being configured to circulate liquid for generating thermal energy. The system further includes a plurality of solar electric roof tiles mounted on the plurality of metal battens. The plurality of solar roof tiles is a building integrated photovoltaic roof tile having a solar module that glued to an eternit tile. Each of the plurality of solar electric roof tiles mounted on the plurality of metal battens, each of the plurality of solar electric roof tiles connected in series to form a string. The metal battens are normally designed to hold roof tiles thereon or regular roof tiles or shingle could also be applicable. As the roof dimensions may vary according to roof design, a starter section is provided that adjusts the string of the plurality solar electric roof tiles accordingly. A plurality of heat pipes positioned in the roof space extends substantially from the ridge to eaves of the roof.

The present invention further illustrates a pump and thermal control system. The thermal control system is connected to an input section and an output section of the thermal tubing, and the thermal control system comprises, a liquid storage unit for storing the liquid therein. A pump to receive the liquid from the liquid storage unit and circulate the liquid to the thermal tubing structure. A heat exchanger connected to the liquid storage unit and the pump, the heat exchanger being adaptable to exchange heat from the liquid. A drain valve that transfers the liquid received from the pump to the thermal tubing structure and drains excess liquid in a controlled manner. A check valve to regulate the flow of air and fill valve that receives the liquid from the drain valve and regulates the filling of liquid into the thermal tubing structure through the input section. A forward gauge assembly having a first temperature gauge and a first pressure gauge to check the temperature and pressure of the liquid flowing from the fill valve. A backward gauge assembly having a second temperature gauge and a second pressure gauge to check the temperature and pressure of the liquid flowing from the output section of the thermal tubing structure. A flow sight glass to regulate the flow liquid from the thermal tubing structure. An air eliminator to release the air from the thermal tubing structure. An expansion tank to collect and expand the air coming from the air eliminator. A Styrofoam (not shown) is insulated through the expansion tank. A pressure relief valve to provide safety to the thermal tubing structure and an energy storage tank to store the heated liquid received from the output section of the thermal tubing structure.

The present invention discusses in detail where a modular thermal system could be lifted by a crane and mounted the battens on the roof of the building. Moreover, the installers just have to connect the modular thermal system together on the roof of the building. Once the modular thermal system is connected, a pump and thermal control system is connected between the tank and the modular thermal system. Thereby a modular building integrated thermal system provides an easy installation with a removable modular structure.

### BRIEF DESCRIPTION OF THE DRAWINGS

FIG. 1 illustrates a layout of a building integrated modular thermal unit in accordance with a preferred embodiment of the present invention;

FIG. 2 illustrates a block diagram of the pump and thermal control system in accordance with the present invention;

FIG. 3 illustrates building integrated modular thermal system installed on a house in accordance with a preferred embodiment of the present invention;

FIGS. 4A and 4B illustrates shows a schematic view of the metal battens and a heat pipe holder utilized in accordance with a preferred embodiment of the present invention.

FIG. 5 is a flow chart for a method of mounting a modular building integrated thermal system in accordance with a preferred embodiment of the present invention;

FIG. 6 illustrates a schematic diagram of a modular building integrated thermal system in accordance with a preferred embodiment of the present invention;

FIGS. 7A and 7B illustrate a parallel thermal tubing layout of a modular building integrated thermal system in accordance with a preferred embodiment of the present invention.

### DETAILED DESCRIPTION OF THE PREFERRED EMBODIMENT

The following describes example embodiments in which the present invention may be practiced. This invention, however, may be embodied in many different ways, and the description provided herein should not be construed as limiting in any way. Among other things, the following invention may be embodied as methods or devices. As such, the present invention may take the form of an entirely hardware embodiment, an entirely software embodiment, or an embodiment combining software and hardware aspects. The following detailed descriptions should not be taken in a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

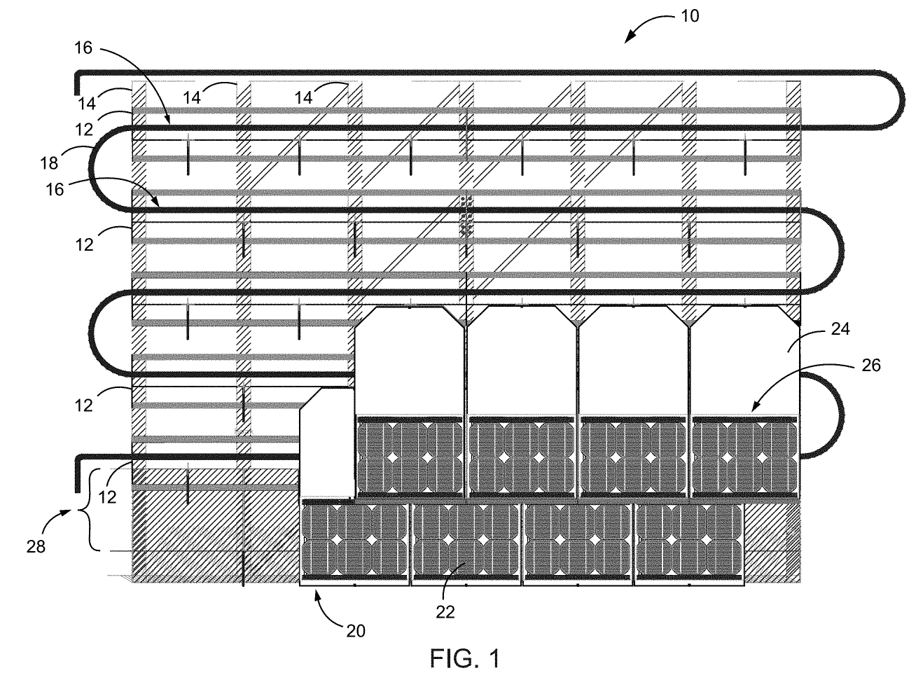

Referring to FIG. 1, illustrates a layout of a building integrated modular thermal system. A modular thermal unit 10 that comprises a plurality of metal battens 12 mounted horizontally onto a plurality of wooden battens 14 that mounted vertically across a roof (not shown). Each of the plurality of metal battens 12 includes a longitudinal channel 16 that extends in a longitudinal direction on opposing sides thereof. A thermal collector having a thermal tubing 18 structure extending along the longitudinal channel 16, the thermal tubing 18 structure being configured to circulate liquid for generating thermal energy. The system further includes a plurality of solar electric roof tiles 20 mounted on the plurality of metal battens 12. The plurality of solar roof tiles 20 is a building integrated photovoltaic roof tile having a solar module 22 that glued to an eternit tile 24. Each of the plurality of solar electric roof tiles 20 mounted on the plurality of metal battens 12, each of the plurality of solar electric roof tiles 20 connected in series to form a string 26. The metal battens 12 are normally designed to hold roof tiles thereon. As the roof dimensions may vary according to roof design, a starter section 28 is provided that adjusts the string 26 of the plurality solar electric roof tiles 20 accordingly. A plurality of heat pipes positioned in the roof space extends substantially from the ridge to eaves of the roof.

Each of the plurality of solar roof tiles 20 is mounted on the plurality of metal battens 12 using a storm anchor hook 29 which is hammered into a hole (not shown) provided in each of the plurality of metal battens 12. The storm anchor hook 29 is designed in such a way that the plurality of solar roof tiles 20 overlaps each other. A plurality of holes (not shown) are drilled in advance on each of the plurality of metal battens 12 according to specified positions which saves time and also simplifies the installation procedures. The specified positions are based on the size of the plurality of solar electric roof tiles 20.

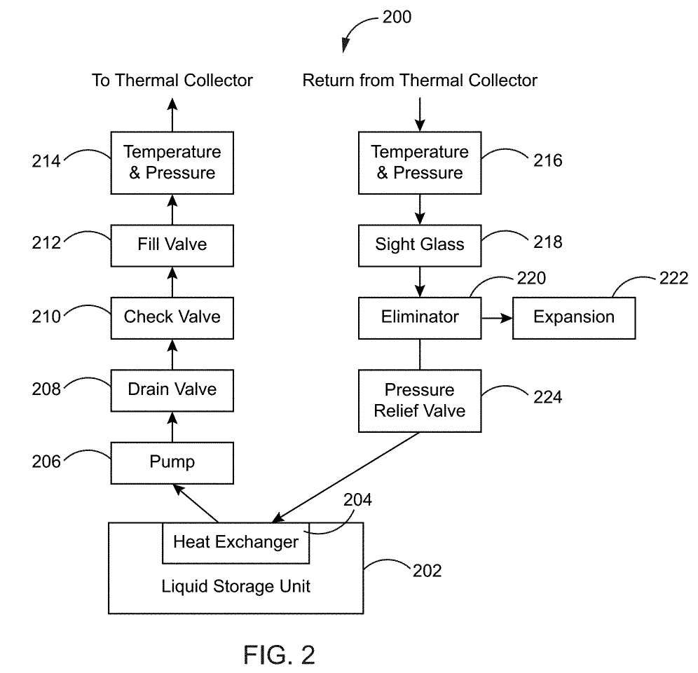

FIG. 2 illustrates a block diagram of the pump and thermal control system 200 in accordance with the present invention. A thermal control system connected to an input section and an output section of the thermal tubing, the thermal control system comprising, a liquid storage unit 202 for storing the liquid therein. A pump 206 receives the liquid from the liquid storage unit 202 and circulates the liquid to the thermal tubing structure. A heat exchanger 204 connected to the liquid storage unit 202 and the pump, the heat exchanger 204 being adaptable to exchange heat from the liquid. A drain valve 208 that transfers the liquid received from the pump 206 to the thermal tubing structure and drains excess liquid in a controlled manner. A check valve 210 regulates the flow of air and fill valve 212 that receives the liquid from the drain valve 208 and regulates the filling of liquid into the thermal tubing structure through the input section. A forward gauge assembly 214 having a first temperature gauge and a first pressure gauge checks the temperature and pressure of the liquid flowing from the fill valve 212. A backward gauge assembly 216 having a second temperature gauge and a second pressure gauge checks the temperature and pressure of the liquid flowing from the output section of the thermal tubing structure. A flow sight glass 218 regulates the flow liquid from the thermal tubing structure. An air eliminator 220 releases the air from the thermal tubing structure. An expansion tank 222 is provided to collect and expand the air coming from the air eliminator. A Styrofoam (not shown) is insulated through the expansion tank. A pressure relief valve 224 is to provide safety to the thermal tubing structure and an energy storage tank 130 stores the heated liquid received from the output section of the thermal tubing structure.

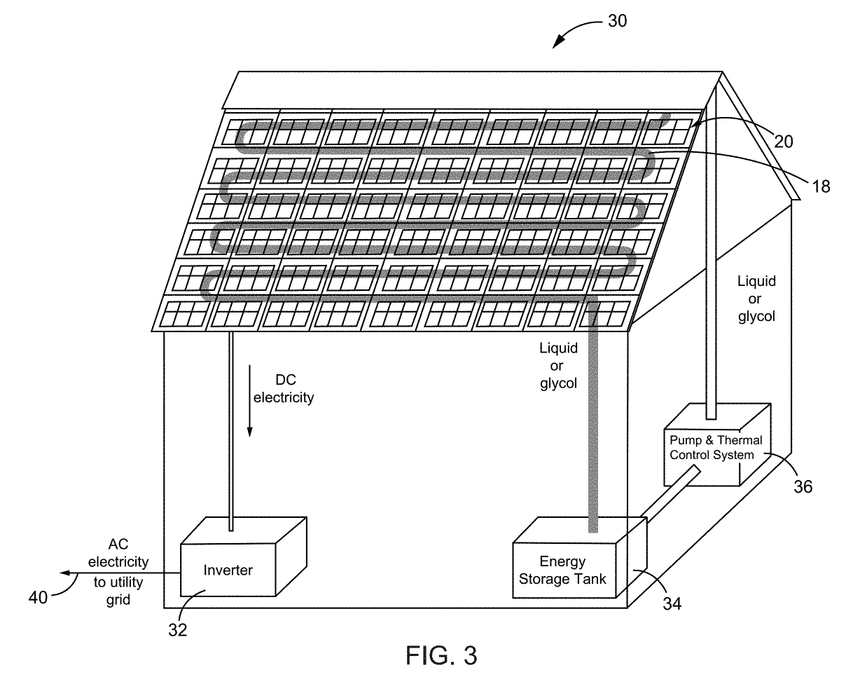

FIG. 3 illustrates building integrated modular thermal system installed on a house 30. In the present invention, a thermal system and an electric system work in conjunction as well as compensate with each other. As shown, the present invention further comprises an inverter 32 connected to each string 26, a pump and thermal control system 36 is connected between an energy storage tank 34 from a thermal tubing 18, The thermal tubing 18 in the present invention may be PEX, brass, copper, or aluminum tubing and liquid running through the thermal tubing 18 may be water or glycol. Each string 26 can be connected to the inverter 32 or numerous strings can be connected in parallel to the inverter 32 in another embodiment of the invention.

The plurality of solar roof tiles 20 generates DC electricity as the solar energy hits a surface of the plurality of solar roof tiles 20. The inverter 32 converts the DC electricity to AC electricity and feeds to a utility grid 38. The plurality of metal battens 12 collects the solar energy and converts into thermal energy through running the liquid in the thermal tubing 18 throughout the roof (not shown). The thermal energy is extracted down to the heat exchanger 34 resulting in heating up the domestic water supply and providing domestic hot water. As the thermal energy is extracted to the heat exchanger 34, the plurality of solar electric roof tiles 20 is cooled thereby making the plurality of solar electric roof tiles 20 operate at high efficiency in converting the solar energy to DC electricity. Moreover, as the modular thermal unit 10 captures more solar energy, the modular thermal unit 10 has much high energy conversion rate thereby reducing HVAC power consumption. In the preferred embodiment, modular thermal unit and the electric system operate simultaneously to generate domestic hot water and electricity respectively.

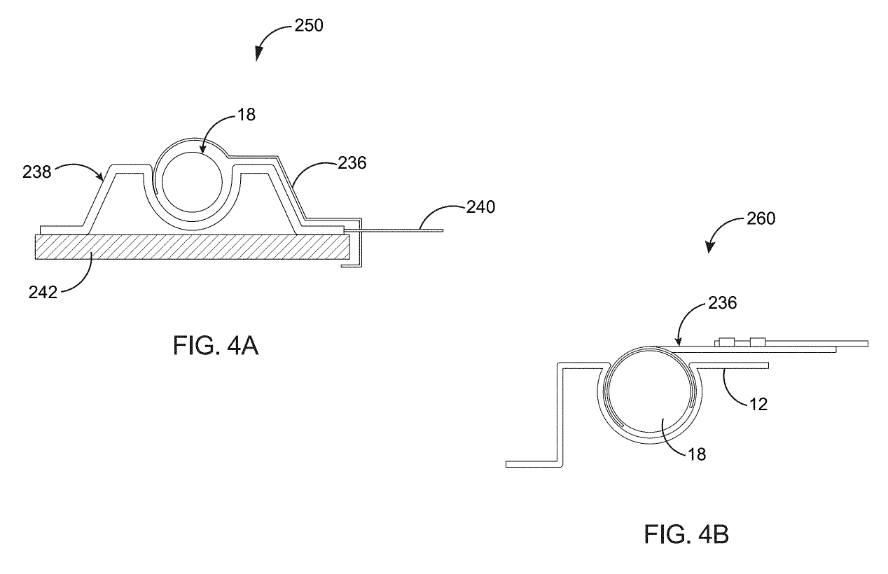

FIGS. 4A and 4B illustrate a schematic view of the metal battens 12 and a heat pipe holder 236 utilized in the preferred embodiment. Each of the plurality of metal battens 12 includes the longitudinal channel 16 that extends in the longitudinal direction on the opposing sides thereof. The plurality of metal battens 12 is mounted horizontally onto the plurality of wooden battens 14 that mounted vertically across a roof (not shown). The thermal tubing 18 is extended along the longitudinal channel 16 in the longitudinal direction and mounted to the plurality of metal battens 12. Thus, the metal batten 12 alone holds the thermal tubing 18 and the plurality of solar electric roof tiles 20. A plurality of heat pipes 240 positioned in the roof space extends substantially from the ridge to eaves of the roof. The spacing between the each of the plurality of metal battens 12 can be varied subject to the size of the plurality of solar electric roof tiles 20 and the required thermal specification. As the plurality of metal battens 12 are more tightly spaced, more thermal tubing 18 can be installed to achieve high thermo energy conversion efficiency. The at least one heat pipe 240 is mounted to the thermal tubing utilizing a heat pipe holder 236. The heat pipe holder 236 includes a circular bracket that is sniped onto the thermal tubing 18. A flat metal piece is welded onto the circular bracket with two notch punched out. The notches is adaptable to hold the at least one heat pipe.

The plurality of heat pipe 240 is mounted to the thermal tubing utilizing a heat pipe holder that is mounted to the plurality of wooden battens. The heat pipe holder 236 includes a circular bracket that is sniped onto the thermal tubing. A notch is punched out on at least one purlin 238 to hold the at least one heat pipe. A fiberglass insulation 242 is installed between the purlins 238.

In one aspect of the present invention to capture a more thermal energy from the solar, the heat pipe 240 could be applied onto the thermal system. The metal batten 12 and the purlins 238 holds the thermal tubing 18 by utilizing a pair of heat pipe holder 236 to mount on the thermal tubing. The metals batten 12 having a circular bracket that could be sniped onto the thermal tubing. A flat metal piece is welded onto the circular bracket with a pair of notch punched out that would be used to hold the heat pipe 240. Moreover, in the purlin 238 the heat pipe holder 236 would be locked onto the wooden or fiber glass and the circular side of the holder could be sniped right onto the thermal tubing. A notch is punched out to hold the heat pipe.

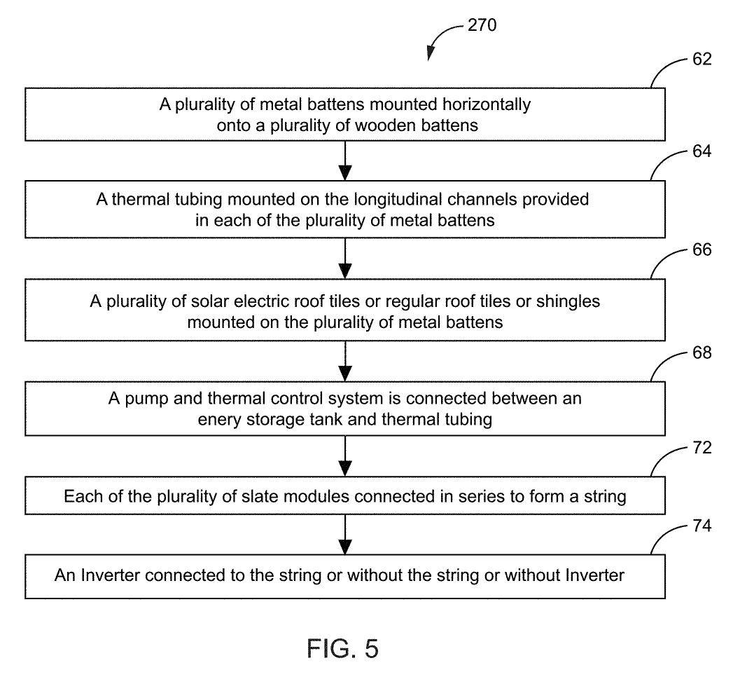

FIG. 5 is a flow chart for a method of mounting a modular building integrated thermal system. As shown in step 62, a plurality of metal battens is mounted horizontally onto a plurality of wooden battens. A thermal tubing system is mounted on the longitudinal channels provided in each of the plurality of metal battens as shown in step 64. A plurality of solar electric roof tiles is mounted on the plurality of metal battens using a storm anchor hook as shown in step 66 or any other regular roof tiles or shingles could also be mounted in case the customer does not need the photovoltaic roof tiles. Each of the plurality of slate modules is connected in series to form a string as shown in step 72. As shown in step 74, an inverter is connected to each of the strings. As shown in step 68, a pump and thermal control module is connected between an energy storage tank and thermal tubing.

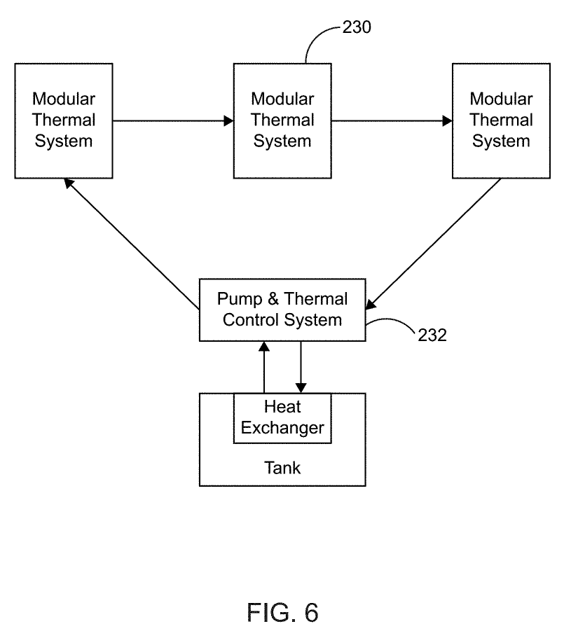

FIG. 6 illustrates a schematic diagram of a modular building integrated thermal system. The modular thermal system 30 could be lifted by a crane and mounted the battens on the roof of the building. Moreover, the installers just have to connect the modular thermal system together on the roof. Once the modular thermal system is connected, a pump and thermal control module 232 is connected between the tank and the modular thermal system. Thereby a modular building integrated thermal system provides an easy installation with a removable modular structure.

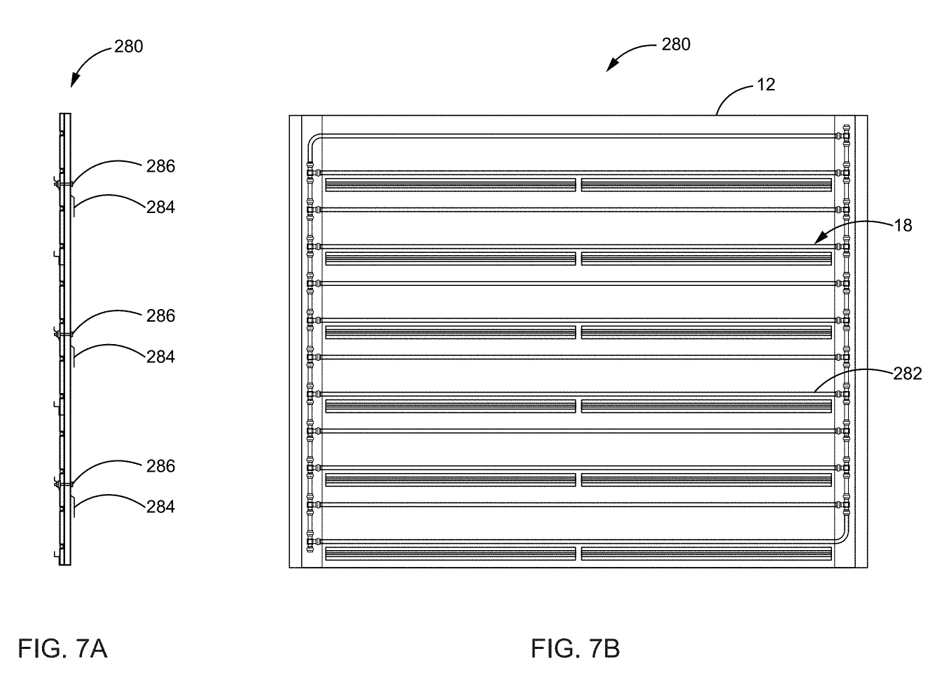

FIGS. 7A and 7B illustrate a parallel thermal tubing layout 280 of a modular building integrated thermal system in accordance with a preferred embodiment of the present invention. In this embodiment, the thermal tubing structure 18 includes thermal tubes 282 that are arranged parallel to the length of the system so as to minimize the heat transfer surface requirements thereby providing good temperature balance and minimum thermal stresses developed in the tubes. The parallel thermal tubes 282 are installed to the plurality of metal battens 12 utilizing at least one securing means 284. Preferably, the at least one securing means is a hybrid cleat. The outside edge is the hybrid cleat 284 which is 6″ from vertical edges of a 1″ thick solid foam board. Each solid foam board includes 6 hybrid cleats. The hybrid cleats 284 are attached to the plurality of metal battens 12 using screws 286 inserted through drill holes on the hybrid cleat 284 and metal battens 12. The thermal tubes 282 are preferably flexible, cross-linked polyethylene tubing, (e.g. Wirsbo AquaPEX™ type).

While a particular form of the invention has been illustrated and described, it will be apparent that various modifications can be made without departing from the spirit and scope of the invention. Accordingly, it is not intended that the invention be limited, except as by the appended claims.

What is claimed is:

1. A building integrated modular thermal system, comprising:
a modular thermal unit comprising:
a plurality of metal battens mounted horizontally onto a plurality of wooden battens that are mounted vertically across a roof, each of the plurality of metal battens including a longitudinal channel that extends between a pair opposing sides in a longitudinal direction;
a thermal collector having a thermal tubing structure extending along the longitudinal channel, the thermal tubing structure being configured to circulate liquid for generating thermal energy;
a plurality of heat pipes positioned in the roof space extends substantially from the ridge to eaves of the roof;
a thermal control system connected to an input section and an output section of the thermal tubing, the thermal control system comprising:
a liquid storage unit for storing the liquid therein;
a pump to receive the liquid from the liquid storage unit and circulate the liquid to the thermal tubing structure;
a heat exchanger connected to the liquid storage unit and the pump, the heat exchanger being adaptable to exchange heat from the liquid;
a drain valve that transfers the liquid received from the pump to the thermal tubing structure and drains excess liquid in a controlled manner;
a check valve to regulate the flow of air; and
a fill valve that receives the liquid from the drain valve and regulates the filling of liquid into the thermal tubing structure through the input section;
a forward gauge assembly having a first temperature gauge and a first pressure gauge to check the temperature and pressure of the liquid flowing from the fill valve;
a backward gauge assembly having a second temperature gauge and a second pressure gauge to check the temperature and pressure of the liquid flowing from the output section of the thermal tubing structure;
a flow sight glass to regulate the flow liquid from the thermal tubing structure;
an air eliminator to release the air from the thermal tubing structure;
an expansion tank to collect and expand the air coming from the air eliminator;
a styrofoam being insulated through the expansion tank;
a pressure relief valve to provide safety to the thermal tubing structure; and
an energy storage tank to store the heated liquid received from the output section of the thermal tubing structure;
a thermal tubing containing liquid mounted and extending on the longitudinal channels of each of the plurality of metal battens;
a plurality of solar electric roof tiles mounted on the plurality of metal battens, each of the plurality of solar electric roof tiles connected in series to form a string;
an inverter connected to each string for converting direct current (DC) electricity that fed from the plurality of solar electric roof tiles to alternating current (AC) electricity;
a heat exchanger connected to the thermal tubing; and
a pump connected between the thermal tubing and the heat exchanger for circulating the liquid through the thermal tubing;
whereby the modular thermal unit and the thermal control system provides an easy installation with a removable modular structure.

2. The building integrated modular thermal system of claim 1 wherein the plurality of solar roof tiles may be a building integrated photovoltaic roof tile having a solar module that glued to an eternit tile.

3. The building integrated modular thermal system of claim 1 wherein each of the plurality of solar roof tiles is mounted on the plurality of metal batten using a storm anchor hook which is hammered into a hole provided in each of the plurality of metal battens.

4. The building integrated modular thermal system of claim 1 wherein the inverter converts the DC electricity to AC electricity and feeds to a utility grid.

5. The building integrated modular thermal system of claim 1 wherein the plurality of metal battens collects the solar energy and converts into thermal energy through running the liquid in the thermal tubing throughout the roof.

6. The building integrated modular thermal system of claim 6 wherein the thermal energy is extracted to the heat exchanger resulting in heating up the domestic water supply and providing domestic hot water.

7. The building integrated modular thermal system of claim 7 wherein as the thermal energy is extracted to the heat exchanger, the plurality of solar electric roof tiles is cooled thereby making the plurality of solar electric roof tiles operate at high efficiency in converting the solar energy to DC electricity.

8. A building thermal system, comprising:
a thermal unit having a plurality of battens mounted onto a one or more battens,
a thermal collector having a tubing structure extending along the channel, the thermal tubing structure being configured to circulate liquid for generating thermal energy;
a plurality of heat pipes positioned in a roof space
a thermal control system connected to an input section and an output section of the tubing, the thermal control system comprising:
a pump to receive the liquid from the liquid storage unit and circulate the liquid to the tubing structure;
a heat exchanger connected to the liquid storage unit and the pump;
of liquid into the thermal tubing structure through the input section;
a tubing containing liquid mounted and extending on the channels of each of the plurality of battens;
an inverter for converting direct current (DC) electricity to alternating current (AC) electricity;
a heat exchanger connected to the thermal tubing; and
a pump connected between the thermal tubing and the heat exchanger for circulating the liquid through the tubing.

9. The building integrated modular thermal system of claim 1 wherein the plurality of solar roof tiles may be a building integrated photovoltaic roof tile having a solar module that glued to an eternit tile.

10. The building integrated modular thermal system of claim 1 wherein each of the plurality of solar roof tiles is mounted on the plurality of metal batten using a storm anchor hook which is hammered into a hole provided in each of the plurality of metal battens.

11. The building integrated modular thermal system of claim 1 wherein the inverter converts the DC electricity to AC electricity and feeds to a utility grid.

12. The building integrated modular thermal system of claim 1 wherein the plurality of metal battens collects the solar energy and converts into thermal energy through running the liquid in the thermal tubing throughout the roof.

13. The building integrated modular thermal system of claim 6 wherein the thermal energy is extracted to the heat exchanger resulting in heating up the domestic water supply and providing domestic hot water.

14. The building integrated modular thermal system of claim 7 wherein as the thermal energy is extracted to the heat exchanger, the plurality of solar electric roof tiles is cooled thereby making the plurality of solar electric roof tiles operate at high efficiency in converting the solar energy to DC electricity.

15. A method of mounting a building integrated thermal electric hybrid roofing system, the method comprising the steps of:
a. mounting a plurality of metal battens horizontally onto a plurality of wooden battens that is mounted vertically across a roof, each of the plurality of metal battens includes a longitudinal channel that extends in a longitudinal direction on a pair of opposing sides thereof;
b. mounting a thermal tubing containing liquid on the longitudinal channels of each of the plurality of metal battens;
c. mounting a plurality of solar electric roof tiles on the plurality of metal battens using a storm anchor hook which is hammered into a hole provided in each of the plurality of metal battens;
d. connecting each of the plurality of solar electric roof tiles in series to form a string;
e. connecting an inverter to each string for converting the DC electricity that fed from the plurality of solar electric roof tiles to AC electricity;
f. connecting a heat exchanger to the thermal tubing for extracting the thermal energy; and
g. connecting a pump between the thermal tubing and the heat exchanger for circulating the liquid running through the thermal tubing.

16. The method of claim 16 wherein the plurality of solar roof tiles may be a building integrated photovoltaic roof tile having a solar module glued to an eternit tile.

17. The method of claim 16 wherein the plurality of solar roof tiles generates DC electricity as the solar energy hits a surface of the plurality of solar roof tiles.

18. The method of claim 16 wherein the thermal energy is extracted to the heat exchanger resulting in heating up the domestic water supply and providing domestic hot water.
